(19) United States
(12) Patent Application Publication
(10) Pub. No.: US 2009/0107767 A1
(43) Pub. Date: Apr. 30, 2009

(54) WORKHORSE APPARATUS, SYSTEM AND METHOD

(76) Inventor: Kenneth C. Long, Lincoln, NE (US)

Correspondence Address: BERENBAUM, WEINSHIENK & EASON, P.C, 370 17TH STREET, SUITE 4800, DENVER, CO, 80202, US

(21) Appl. No.: 12/260,891

(22) Filed: Oct. 29, 2008

Related U.S. Application Data
(60) Provisional application No. 60/983,400, filed on Oct. 29, 2007.

(51) Int. Cl. B25H 1/06

(52) U.S. Cl. 182/186.1; 182/186.5; 182/225; 182/230

(57) ABSTRACT

A support apparatus having a first support element with at least one slot defined therein and a second support element with at least one slot defined therein; and one or more connective structures, wherein the first and second support elements are adapted to be secured together by the one or more connective structures by the disposition of the one or more connective structures within the respective slots of the first and second support elements.

### CROSS-REFERENCE TO RELATED APPLICATIONS

The present application claims priority from the U.S. Provisional Application No. 60/983,400, filed 29 Oct. 2007, entitled “WORKHORSE APPARATUS AND METHOD”; the subject matter of which hereby being specifically incorporated herein by reference for all that it discloses and teaches.

### BACKGROUND

The present development is directed to a readily assembled support structure, but more particularly to a workhorse of the type typically used as a support for cutting wood, inter alia.

When working with wood or other sawable or otherwise workable materials, it is often desirable for an operator to have a sturdy, lightweight, and yet reliable support structure upon which to set and saw the subject material. Without a suitable support structure allowing for support for the wood as well as a clear path for the saw, the operator might risk inaccuracy, or damage to the supporting surface.

Ordinarily, such an operator would use a conventional sawhorse or workhorse. A workhorse is generally understood to be a frame or trestle that supports wood or other material for sawing or other work maneuvers. Such a sawhorse or workhorse may take the form of a beam with four legs. A typical sawhorse may support one end of a board or a plank. The typical sawhorse may be then paired with another sawhorse and be used to support a board or plank for sawing or other working. Generally, the piece of wood to be sawed or otherwise worked is placed on and between the two sawhorses, and the operator saws or works the wood between the two points of support afforded by the sawhorses.

Sawhorses have been designed in some cases to be foldable, to facilitate transportation and storage. Two sawhorses may be used to create a portable work table, by placing a flat surface, such as a door or a large flat piece of wood, atop two sawhorses. A pair of sawhorses may also support a plank to form a scaffold. A sawhorse may be wide-topped, to singly support a board for sawing, or to support a larger surface for use as a workbench, but wider-topped sawhorses have the disadvantage of being more difficult to transport and store.

Thus, it may be desirable to have a lightweight, easily portable, easily assemblable and disassemblable device that may provide a secure and stable support structure for an operator performing sawing or other workpiece functions.

### SUMMARY

The present disclosure relates to a workhorse apparatus and/or system and/or method by which the workhorse apparatus may be used; namely, a first support element designed to be used in conjunction with a substantially similar second support element; the first and second support elements each having an opening or aperture, or openings or apertures, disposed to be adapted to receive a connective structure or structures for the purpose of supportively connecting the first support element and the second support element.

In many instances, the first support element and the second support element, when joined together by one or more connective structures, could be used for sawing or other workpiece working purposes. The entire workhorse apparatus may be adapted to be transported with ease and assembled using both preconstructed and readily available materials. The openings or apertures of the first and second support structures may be adapted to receive existing connective structures of a readily available size and composition, such as a wooden two-by-four. Otherwise, the support elements may have a various number of openings of various shapes and be adapted to receive a variety of different connective structures.

### BRIEF DESCRIPTION OF THE DRAWINGS

In the drawings:

FIG. 1 provides a side elevational view of a workhorse apparatus including a first support element, a second support element, and a connective structure;

FIG. 2, provides another side elevational view of one of the support elements of the workhorse featuring openings adapted to receive one or more of a connective structure;

FIG. 3, provides an isometric view of the workhorse apparatus as assembled with both support elements and two connective structures;

FIG. 4, which includes sub-part FIGS. 4A and 4B, shows partial sectional views of an apparatus hereof.

FIG. 5, provides another isometric view of another implementation of a workhorse as assembled with two support elements and two connective structures, as well as two surface support elements, a first surface support element atop the first support element and the second surface support element atop the second support element;

FIG. 6, provides another side elevational view of the workhorse of FIG. 5 as assembled with both first and second support element and one connective structure visible, as well as two surface support elements, a first surface support element atop the first support element and the second surface support element atop the second support element, and two ground support elements, a first ground support element at the base of the first support element and the second ground support element at the base of the second support element;

FIG. 7 provides another side elevational view of the first support element with a first surface support element and a first ground support element, and featuring openings adapted to receive one or more connective structures.

### DETAILED DESCRIPTION

The developments hereof relate to a workhorse apparatus typically configured to enable easy transportation, assembly, use, and disassembly, and a system and method of use thereof. In many implementations, the workhorse apparatus has first and second support elements which are adapted to be attached by a connective structure, typically, a connective structure which in many cases may be readily found in a venue where sawing or other material working is done. Such a connective structure may in some instances be a typically dimensioned piece of wood, such as, for example a two-by-four or a piece of wood of similar dimensions. In some implementations, the workhorse apparatus may be adapted to have a work surface support element to provide enhanced stability for any workpiece being placed upon the workhorse apparatus to be worked. In other implementations, the workhorse apparatus may be adapted to have a ground support element to provide stability for the workhorse apparatus itself by providing an increased footprint for the workhorse apparatus.

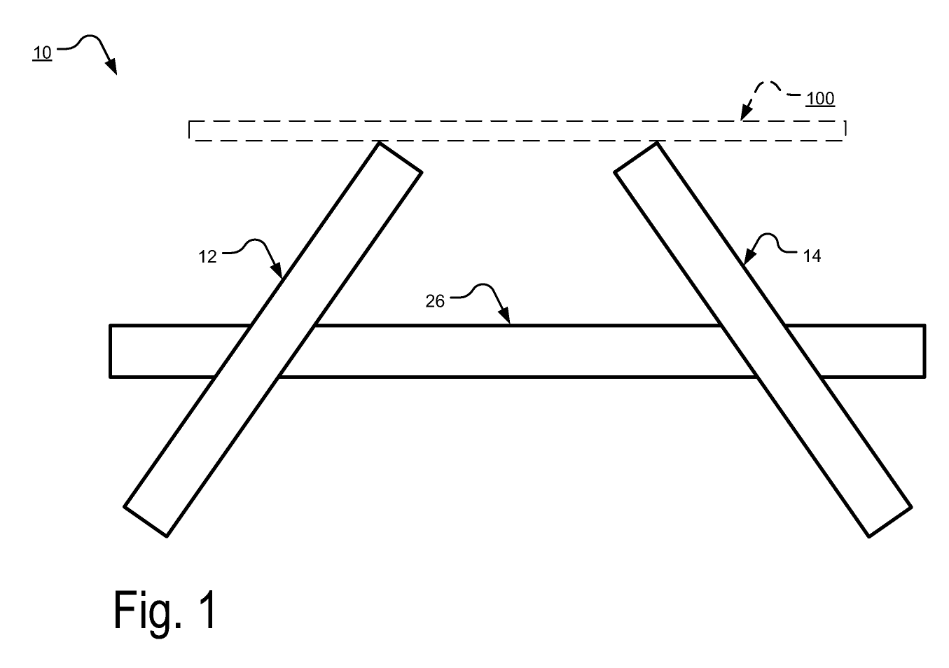

As generally shown in FIG. 1, an implementation of a workhorse apparatus 10, as such may typically be used in a typical construction environment, may have a first support element 12 and a second support element 14, and be adapted to be mounted together with at least one connective structure; here, the visible connective structure 26. The connective structure 26 may be of virtually any suitable sort, although possibly of a readily available material and readily available dimensions, such as a wooden two-by-four. A workpiece 100 is shown in dashed lines as it might be disposed for work on apparatus 10.

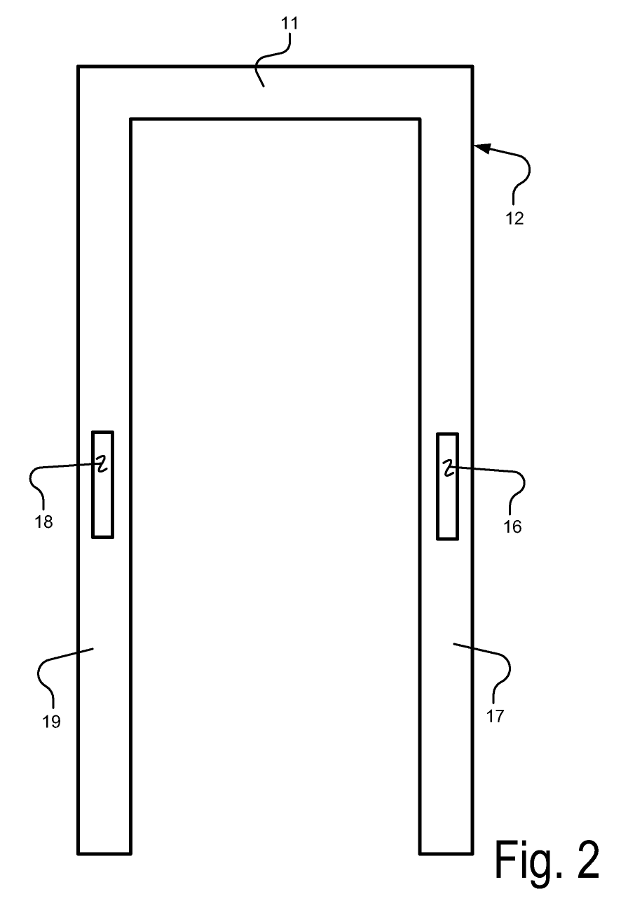

In the depiction of a first support element 12 in FIG. 2, a first aperture or slot 16 may be disposed within the first vertical element 17 of the support element, and a second aperture or slot 18 may be disposed within the second vertical element 19 of the support element 12. In FIG. 2, the first support element 12 depicted is shown without any connective structure, and rather is depicted in its undeployed state to illustrate the general location and dimension of the first aperture 16 and second aperture 18.

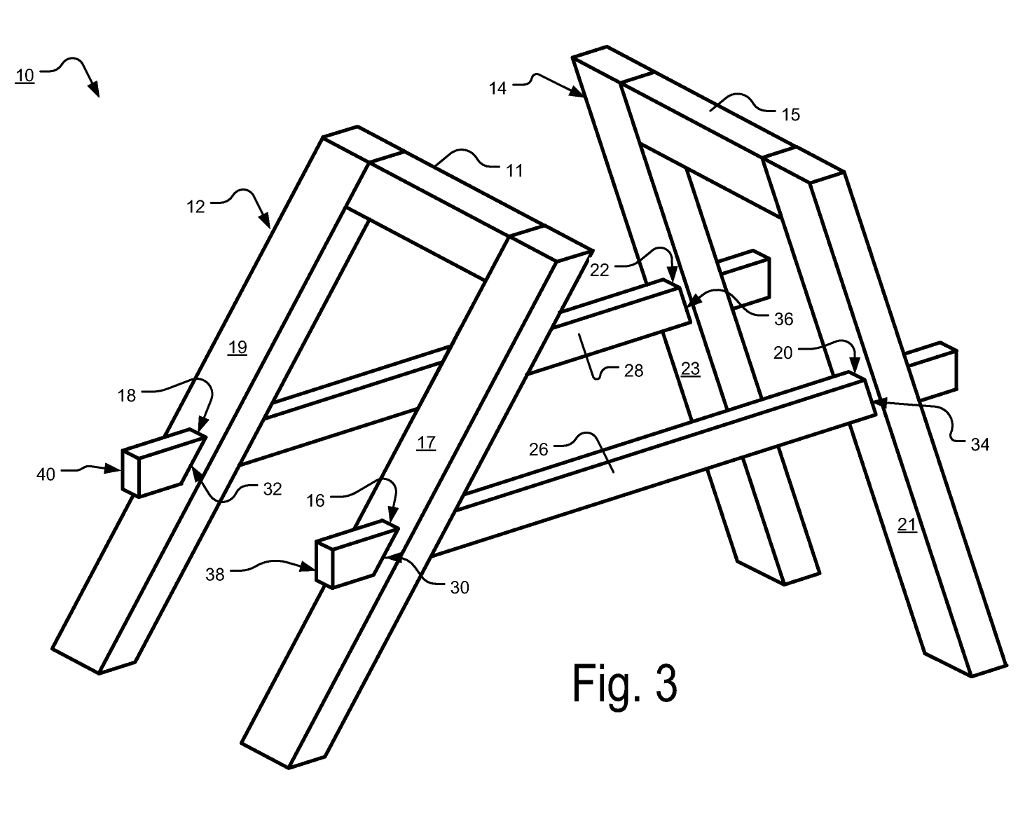

The size and location of the first aperture 16 and the second aperture 18 may be generally similar, and may be of any suitable dimension and placement, and may be matched by the corresponding apertures on the second support element 14 (not depicted in this FIG. 2). The size and location of the apertures 16 and 18 may be pre-formed into and thus be a part of the respective vertical elements 17 and 19. It may also thus be noted that the vertical support elements 17 and 19 of the first support element 12 and the respective apertures 16 and 18 may have a variety of configurations and shapes. Such alternative locations and shapes can thus increase the ability to use a variety of connective structures to couple the first support element 12 to the second support element 14. A connective structure 26, therefore, may extend at an angle out and/or away from the aperture 16, and thus provide connectivity between the first support element 12 and the second support element 14, which may have a corresponding receiving aperture (not shown in FIG. 2, but see FIG. 3 described below) adapted to receive the connective structure 26. Note also shown is a crossbar member 11 of device 12 holding support elements 17 and 19 in operative disposition relative to each other. Note also that similar cross member 15 of support element 14 is shown in FIG. 3.

As shown in the further implementation of FIG. 3, an assembled workhorse apparatus 10 is depicted, including a first support element 12, a second support element 14, a first connective structure 26 and a second connective structure 28. As is shown in FIG. 3, the first connective structure 26 is disposed between first vertical element 17 of the first support element 12 and the first vertical element 21 of the second support element 14, by way of the aperture 16 in the first vertical element 17 of the first support element 12 and the aperture 20 in the first vertical element 21 of the second support element 14. Similarly, the second connective structure 28 is disposed between second vertical element 19 of the first support element 12 and the second vertical element 23 of the second support element 14, by way of the aperture 18 in the second vertical element 19 of the first support element 12 and the aperture 22 in the second vertical element 23 of the second support element 14.

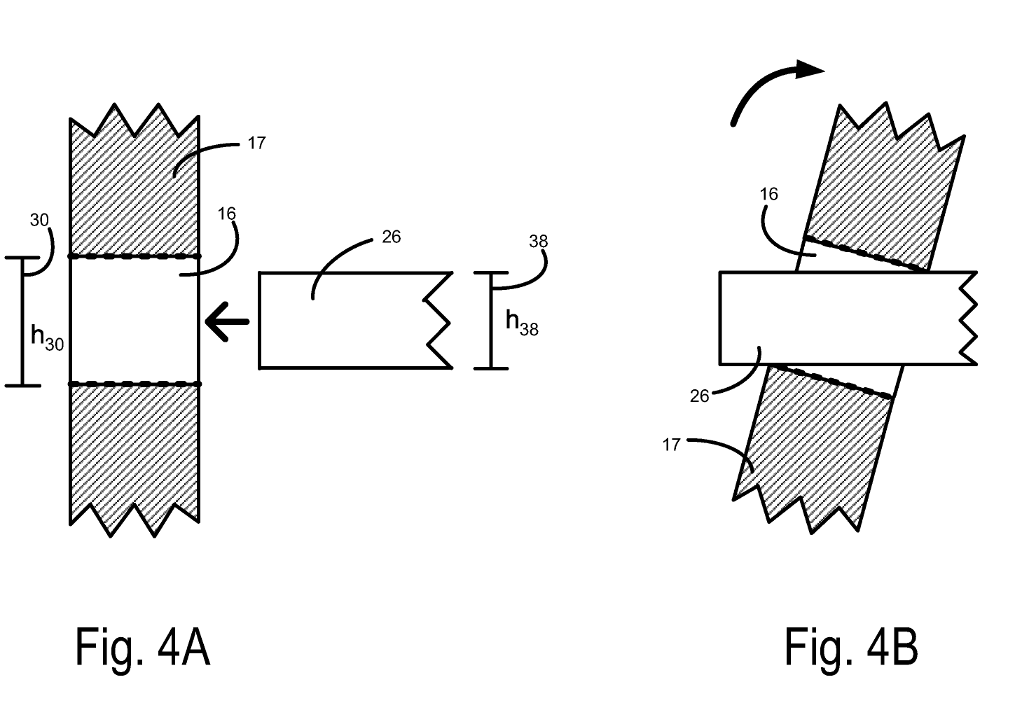

As depicted in this FIG. 3, the connective structures 26, 28 may connectively and supportively couple the first support element 12 and the second support element 14. This is particularly so when as shown in FIGS. 1 and 3, the support elements 12 and 14 are tilted from the vertical toward each other. The stable connection can then be established by the following operations. The insertion of these connective structures 26, 28 may take place when the first support element 12 and the second support element 14 are substantially vertically disposed or substantially perpendicular to the ground. When the first support element 12 and the second support element 14 are in a position substantially vertical or perpendicular to the ground, the apertures 16, 18, 20, 22 may be of dimensions slightly greater than the cross-sectional dimensions of the respective connective structures at the point of insertion. Particularly, the height dimensions 30, 32 of the respective apertures 16, 18 of the first support element 12 may be greater than the height dimensions 38, 40 of the respective connective structures 26, 28; similarly, the height dimensions 34, 36 of the respective apertures 20, 22 of the second support element 14 may be greater than the height dimension 38, 40 of the respective connective structures 26, 28. This is shown in more detail in FIG. 4A.

Then, the first support element 12 and the second support element 14 may be leaned or tilted as depicted in FIG. 4B from their respective perpendicular positions and towards each other, until both the first support element 12 and second support element 14 are leaned to the maximum angle attainable given the dimensions 30, 32, 34, 36 of the respective apertures 16, 18, 20, 22, relative to the height dimensions 38, 40 of the connective structures 26, 28. This is shown for example in FIG. 4B. In this resting, assembled position at this aforementioned maximium angle, due to the angular position of the first support element 12 and the second support element 14, the connective structures 26 and 28 may substantially fill the apertures 16, 18, 20, 22, and thereby hold the entire apparatus in the position shown in FIGS. 1 and 3. Alternatively, and not depicted herein, the apertures could be of an angled dimension that would mirror that of the connective structure. In this alternative embodiment, the first support element 12 and the second support element 14 may be leaned or tilted in order to insert the connective structures 26 and 28.

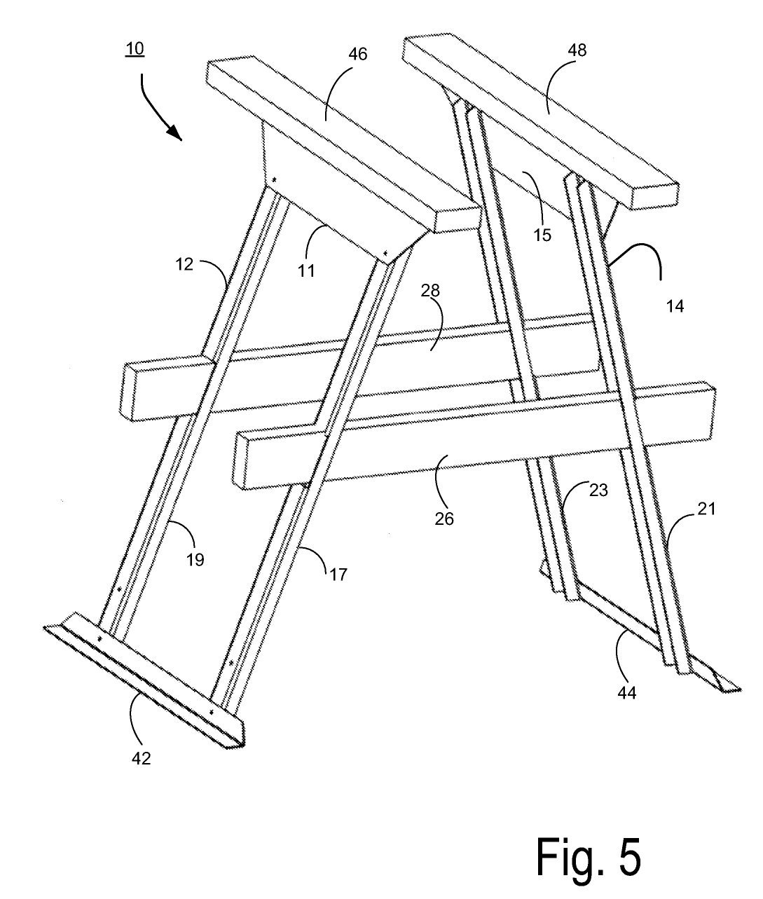

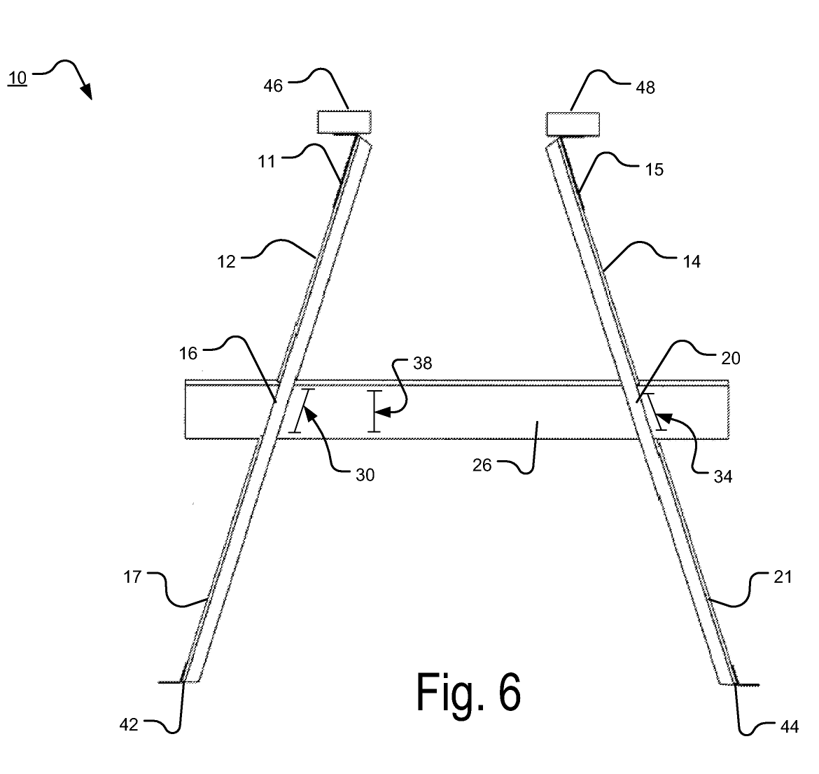

In FIGS. 5 and 6, an alternative apparatus 10 is depicted in assembled position. The first support element 12 and second support element 14 lean towards each other and are supportively connected by the connective structure 26 and the connective structure 28, the latter of which is not shown in FIG. 6. The first support element 12 has a first ground support element, such as a foot or a base 42; the second support element has a similar second ground support element, such as a foot or a base 44. The first support element 12 has a cross member 11 with a first surface support element 46; the second support element 14 has a similar cross member 15 with a second surface support element 48. The surface support elements 46, 48 may form the work surface or surfaces; i.e. a piece of wood or other item to be worked may be placed atop the surface support elements 46, 48 for working, whether for sawing or otherwise. Note, in FIG. 6, the dimensional differences 30, 34 of support slots 16, 20 are also larger than the connective structure height 38.

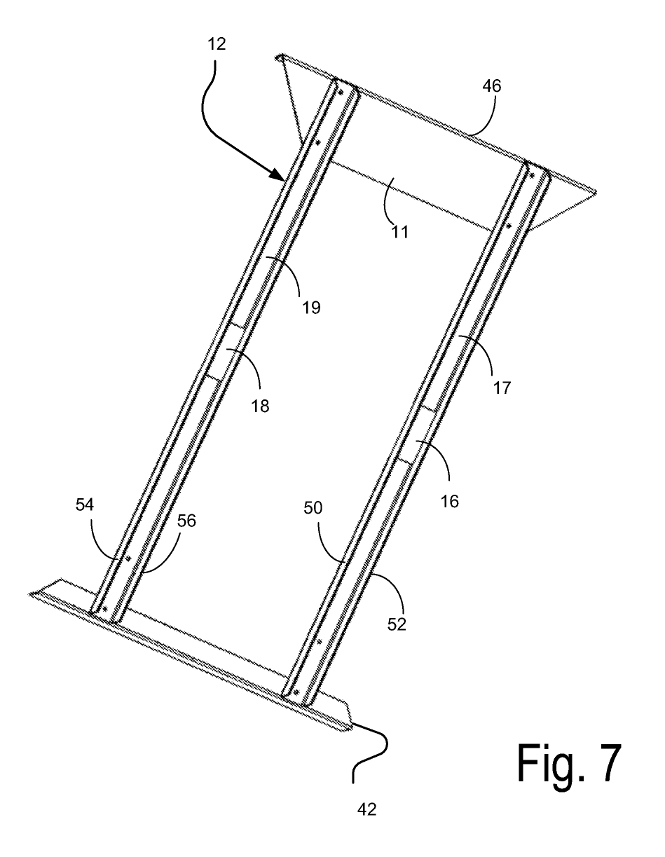

FIG. 7 shows another view of a single support element; here, the first support element 12 of the alternative apparatus 10 of FIGS. 5 and 6. The first vertical element 17 and the second vertical element 19 are shown in greater detail; here, the vertical element 17 may have a ridge or ridges 50, 52 running along the sides of the vertical element 17, which may provide additional stability for apparatus 10; similarly, the vertical element 19 may have a ridge or ridges 54, 56 running along the sides of the vertical element 19, which may also provide additional stability. Although the width of the apertures or slots 16, 18 may correspond generally to the width of the connective structures 26, 28, the ridges 50, 52, 54, 56 may provide additional stability when forces, particularly lateral or torsional forces, may be applied to the structure by the action of working as in sawing.

An apparatus such as any of the support apparatuses as described above may thus provide convenient and portable ways to transport and deploy a workhorse in such a manner as to make it highly advantageous to the operator. The ease and/or quickness of assembly and the ready availability of the materials to be used for the connective structures can be attractive features for an operator requiring a cost-efficient and space-efficient means of obtaining a working surface. Thus, it would not be necessary to sell or carry specialized connective structures; the operator may find a suitable connective structure such as a two-by-four at, for example, a job site or a hardware store. Markets for use hereof may include places where two-by-fours are frequently used, such as construction sites or similar venues. Moreover, when dissembled, the workhorse hereof will be space-saving in that there will be four substantially flat pieces easily portable and storable until re-use as desired. Then, easy assembly as described above may be achieved, i.e. insertion of a two-by-four or other connective structures in each of corresponding slots in respective support elements, then tilting to the finished, assembled position, for use.

As introduced above, a variety of alternative structures may implement the apparatuses hereof. Structures described herein may come in different forms. Thus, the connective structure may be other than a two-by-four, and may be specially formed to be adapted to the overall sawing apparatus. Support structures may be structures other than those specified herein. Moreover, though structures have been shown and described in some detail herein, the scope and content hereof is not so limited, and instead may include alternative structures. Still furthermore, the connection mechanisms hereof are illustrative only as well and not limitative of the scope and content hereof. Other connection mechanisms may be used to the same or substantially the same effect, and thus be covered hereby.

Apparatuses hereof may be made by any of a variety of methods and/or of a variety of materials. In many instances, wood may be the most convenient material for the connective structures. Metal or wood or other suitably hard materials may form the support elements and the feet. Wood or other suitable materials may form the surface support structures. Shapes and sizes are not limited to those shown and described here either, as sizes and shapes may be selected to adapt to any of many alternative structures.

Although the present development has been described with reference to preferred implementations, workers skilled in the art will recognize that changes may be made in form and detail without departing from the spirit and scope of the development described herein.

What is claimed is:

1. A support apparatus comprising:
a first support element with at least one slot defined therein;
a second support element with at least one slot defined therein; and
one or more connective structures,
wherein the first and second support elements are adapted to be secured together by the one or more connective structures by the disposition of the one or more connective structures within the respective slots of the first and second support elements.

2. A support apparatus as recited in claim 1, wherein the first support element and the second support element each have respective first and second vertical support elements.

3. A support apparatus as recited in claim 2, wherein each of the first vertical support element and the second vertical support element have one or more longintudinal ridges along all or a portion of the length of the respective support element.

4. A support apparatus as recited in claim 1, wherein the connective structure is an elongated wood piece of standard two-by-four cross sectional dimensions.

5. A support apparatus as recited in claim 1, wherein the first support element has a first surface support element and the second support element has a second surface support element.

6. A support apparatus as recited in claim 1, wherein the first support element has a first foot or base and the second support element has a second foot or base.

7. A support apparatus as recited in claim 1, wherein each of the first vertical support element and second vertical support element of each of the first support element and the second support element has a foot or base.

8. A support apparatus as recited in claim 1, wherein the slots are positioned at the same relative position on each of the first support element and the second support element.

9. A support apparatus as recited in claim 1, wherein the first support element and the second support element are adapted to be connected with one or more of a variety of connective structures.

10. A support apparatus as recited in claim 1, wherein the first support element and the second support element may be positioned at any distance in relation to each other limited only by the length of the connective structure.

11. A support apparatus as recited in claim 1, wherein the first support element and the second support element are made of lightweight and portable materials and designed to be easily transportable.

12. A system for working a workpiece, the system comprising:
a support apparatus comprising a first support element with at least one slot defined therein and a second support element with at least one slot defined therein; and one or more connective structures wherein the first and second support elements are adapted to be secured together by the one or more connective structures by the disposition of the one or more connective structures within the respective slots of the first and second support elements; and
a workpiece to be disposed upon the support apparatus.

13. A system for working a workpiece as recited in claim 12, wherein the workpiece is wood.

14. A system for working a workpiece as recited in claim 12, wherein the connective structure is an elongated wood piece of standard two-by-four cross sectional dimensions.

15. A method for working a workpiece on a support apparatus, the method comprising:
coupling a first support element to a second support element with a connective structure, wherein the first support element has at least one slot described therein and the second support element has at least one slot defined therein; and, wherein the first and second support elements are adapted to be secured together by the connective structures by the disposition of the one or more connective structures within the respective slots of the first and second support elements;
placing a workpiece to be worked atop the assembled support structure; and
working said workpiece.

16. A method for working a workpiece on a support apparatus as recited in claim 15, wherein the workpiece is wood.

17. A system for working a workpiece on a support apparatus as recited in claim 15, wherein the connective structure is an elongated wood piece of standard two-by-four cross sectional dimensions.

18. A method for working a workpiece on a support apparatus as recited in claim 15, wherein working said workpiece is one or more of sawing, cutting, shaping, nailing . . . .
